(19) United States
(12) Patent Application Publication
(10) Pub. No.: US 2006/0245625 A1
(43) Pub. Date: Nov. 2, 2006

(54) Data block detect by fingerprint

(76) Inventors: Johannes Y Tichelaar, Eindhoven (NL); Antonius A.C.M. Kalker, Son (NL)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(21) Appl. No.: 10/550,852

(22) PCT Filed: Mar. 26, 2004
(86) PCT No.: PCT/IB04/00929

§ 371 Date: Sep. 22, 2005

Related U.S. Application Data
(60) Provisional application No. 60/458,771, filed on Mar. 28, 2003.

(51) Int. Cl. G06K 9/00

(52) U.S. Cl. 382/124; 725/25; 340/5.83

(57) ABSTRACT

A system (1) and method for extracting and detecting fingerprints and attaching an associated action to a first fingerprint. A signal comprising a data stream is captured by a fingerprint extractor (9). The fingerprint extractor (9) will extract the first fingerprint of user specified data within the data. An input device (20) is adapted to accept a first command to extract the first fingerprint and accept a second command to attach an associated action to the first fingerprint. A memory device (14) is adapted to store the first fingerprint and the associated action. A fingerprint detector (4) is adapted to capture the signal comprising the data stream, continuously extract a plurality of fingerprints from the data stream, and compare the plurality of fingerprints to the first fingerprint for a match. A control device (7) is adapted to execute the associated action upon detection of a match.

The present invention relates to a system and associated method for generating and detecting fingerprints and attaching an associated action to a generated fingerprint.

### RELATED ART

Capturing a signal comprising data typically does not allow a person to choose to accept only specified data within the data. The data may have content that the person may not choose to use. Thus, there is a need to allow a person to accept only specified data.

The present invention provides a system, comprising: a fingerprint extractor, a fingerprint detector, a control device, an input device, and a memory device, wherein the fingerprint extractor is adapted to accept a signal comprising a data stream and generate a first fingerprint of user specified data existing within the data stream, wherein the input device is adapted to accept a first command to generate the first fingerprint and accept a second command to attach an associated action to the first fingerprint, wherein the memory device is adapted to store the first fingerprint and the associated action, wherein the fingerprint detector is adapted to accept the signal comprising the data stream, continuously extract a plurality of fingerprints from the data stream, and compare the plurality of fingerprints to the first fingerprint stored in the memory device for a match between the first fingerprint and any fingerprint of the plurality of fingerprints, and wherein the control device is adapted to execute the associated action upon detection of a match.

The present invention provides a method, comprising: providing a system comprising a fingerprint extractor, a fingerprint detector, a control device, an input device, and a memory device; receiving by the fingerprint extractor a signal comprising a data stream; receiving by the input device a first command to generate a first fingerprint of specified data within the data steam; extracting by the fingerprint extractor the first fingerprint of the specified data within the data stream; receiving by the input device a second command to attach an associated action to the first fingerprint; storing by the memory device the first fingerprint and the associated action; receiving by the fingerprint detector the signal comprising the data stream and continuously extracting a plurality of fingerprints from the data; comparing by the fingerprint detector the plurality of fingerprints to the first fingerprint for a match between the first fingerprint and any fingerprint of the plurality of fingerprints; and executing by the control device the associated action upon a detection of a said match.

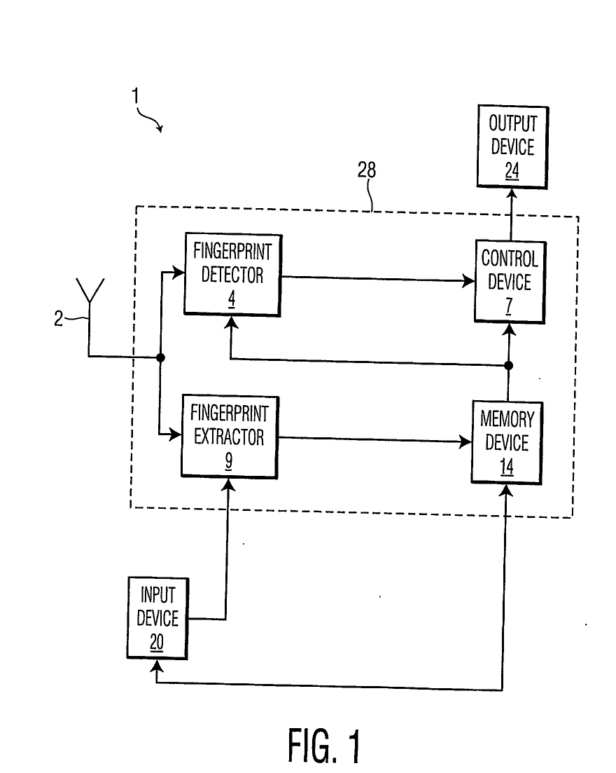

FIG. 1 depicts a block diagram view of a system for creating a fingerprint and attaching an associated action to the fingerprint, in accordance with embodiments of the present invention.

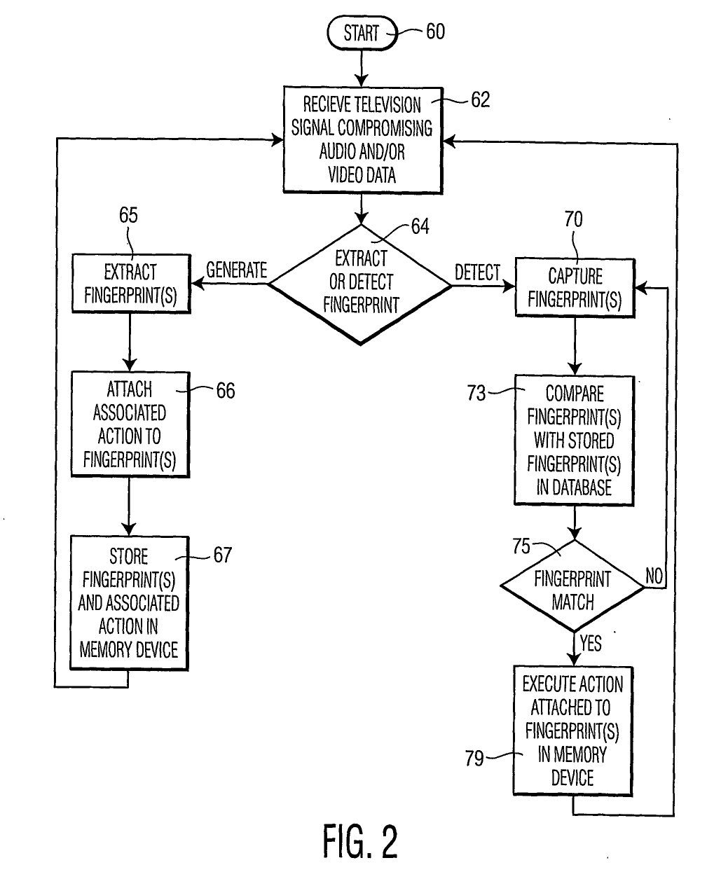

FIG. 2 illustrates a flowchart depicting an algorithm showing a process of FIG. 1 to create the fingerprint and attach the associated action to the fingerprint, in accordance with embodiments of the present invention.

FIG. 1 depicts a block diagram view of a system 1 for creating a fingerprint sequence of user specified data within a signal comprising a data stream and attaching an associated action to the fingerprint, in accordance with embodiments of the present invention. The term “fingerprint” is defined herein as a portion of data used for identification of the data within a data stream. For example, if the data is video data, a fingerprint may comprise a digital word (e.g., sample) that represents one frame or one field of the video data. The fingerprint may comprise a string of digital words representing a plurality of frames or fields of the video data. Fingerprinting and related database techniques are known in the art and are described in: Job Oostveen, Ton Kalker, and Jaap Haitsma, “Feature Extraction and a Database Strategy for Video Fingerprinting,” Visual Information Systems 2002 incorporated herein in it's entirety and in: Jaap Haitsma and Ton Kalker, “A Highly Robust Audio Fingerprinting System,” ISMIR 2002 incorporated herein in it's entirety. The signal may be an electrical signal. The system 1 comprises a fingerprint extractor 9, a fingerprint detector 4, a control device 7, an input device 20, an output device 24, a signal input device 2, and a memory device 14. The signal comprising the data is accepted by the signal input device 2. The system 1 is adapted to disable all or a portion of the user specified data within the data. The term “disable” is defined herein as preventing all or a portion of the user specified data from reaching the output device 24. The signal may comprise, inter alia, a radio signal, a television (TV) signal, etc. The TV signal may comprise, inter alia, a standard radio frequency (RF) TV signal, a cable TV signal, a satellite TV signal, etc. The radio signal may comprise, inter alia, standard RF radio signal, a satellite radio signal, etc. The signal input device 2 may be any signal input device known to a person of ordinary skill in the art including, inter alia, an antenna, a cable TV receiver, a satellite receiver. The data received within the signal may be, inter alia, audio data and/or video data. The fingerprint extractor 9 is adapted to accept the signal comprising the data (e.g., the television signal comprising audio and video data as shown in FIG. 2) and extract a first fingerprint of the user specified data within the signal. The user specified data may comprise, inter alia, TV or radio commercial (advertisement) data, TV show data, TV movie data, etc. The TV or radio commercial may be a single commercial or a block of commercials. The fingerprint extractor may additionally extract a second fingerprint of the user specified data within the signal. The first fingerprint and the second fingerprint may be audio and/or video fingerprints. The input device 20 is adapted to accept a first command by a user to extract the first fingerprint and to extract the second fingerprint thereby creating a fingerprint sequence. Additionally, the input device 20 is adapted to accept a second command by the user to attach an associated action to the fingerprint sequence. An audio and/or video sample of the user specified data that has been marked by the fingerprint sequence and a message regarding the associated action may be additionally attached to the fingerprint sequence for transmission to the output device to give the user feedback data regarding the fingerprint sequence and associated action. For example, if the user specified data is video data the user feedback data may be a down-sampled video frame picture representative of the video data that has been marked by the fingerprint sequence. The fingerprint sequence may mark, inter alia, TV show data, movie data, TV or radio commercial data, etc. The associated action may be comprise, inter alia, muting audio data and/or video data, adjusting a decibel level of audio data, etc. The memory device 14 is coupled to the input device 20 and thus adapted to store the fingerprint sequence, the associated action, and the feedback data. The fingerprint detector 4 is adapted to accept the signal comprising data, extract fingerprints continuously from the data, and compare the fingerprints extracted from the data to the fingerprint sequence stored in the memory device 14 until a fingerprint match is found. The control device 7 is adapted to execute the associated action upon detection of a fingerprint match. The associated action is executed between the first fingerprint and the second fingerprint. For example, the first fingerprint may mark a beginning of commercial data and the second fingerprint may mark an end of the commercial data. The associated action may be to block audio data associated with commercial data from reaching the output device 24 thereby muting the audio data during the transmission of the commercial data. The input device 20 may be any input device known to a person of ordinary skill in the art such as, inter alia, a keypad, a keyboard, a remote control, etc. The input device 20 may also include a processor or be coupled to a processor to process the input as described supra. The memory device 14 may be any memory device known to a person of ordinary skill in the art such as, inter alia, a hard disc drive, an optical disc, a computer disc, flash memory, random access memory, etc. The output device 24 may be any output device known to a person of ordinary skill in the art such as, inter alia, a monitor, a television, etc. The system 1 may comprise a self contained device 28 comprising the fingerprint extractor 9, the fingerprint detector 4, the control device 7, the signal input device 2, and the memory device 14. The system 1 may be coupled to a television (output device 24). Alternatively, the system 1 may be a TV set comprising all of the aforementioned devices. The first fingerprint and the second fingerprint may each comprise, inter alia, a 32 bit word within the user specified data or a word having any number of bits. Alternatively, the first fingerprint and the second fingerprint may each comprise, inter alia, a string of 32 bit words or a string of words having any number of bits. The audio and/or video samples of the user specified data that has been marked by the fingerprint sequence may comprise compressed audio and/or video data. The user may receive audio and/or video feedback regarding the fingerprint sequence and the associated action. The audio and/or video feedback may be presented to the user via the output device 24 as a video and/or audio sample. The associated action may be presented to the user via the output device 24 as, inter alia, a text message, a video message, an audio message, etc.

FIG. 2 illustrates a flowchart depicting an algorithm showing a process of FIG. 1 to create the fingerprint sequence, attach the associated action to the fingerprint, and execute the associated action, in accordance with embodiments of the present invention. Step 60 represents a startup of the process. In step 62, a signal (e.g., a TV signal) comprising audio and/or video data is received by the signal input device 2. In step 64, a choice is made to either create a fingerprint sequence or to detect a plurality of fingerprints. If in step 64, the choice is made to create the fingerprint sequence, the user will input a first command through the input device 20 to the fingerprint extractor 9 to extract the first fingerprint and to extract the second fingerprint thereby creating the fingerprint sequence in step 65. The fingerprint sequence is used to mark the user specified data in accordance FIG. 1. Additionally, in step 66, the user will input a second command through the input device 20 to attach an associated action (e.g., in FIG. 1 description) to the fingerprint sequence. In step 67, the fingerprint sequence and associated action is stored in the memory device 14. After step 67 has been performed, step 62 may be executed again. If in step 64, the choice is made to detect a plurality of fingerprints, the fingerprint detector 4 continuously extracts fingerprints from the signal in step 70 and compares the fingerprints to any fingerprint sequences that may be stored in the memory device 14 (e.g., fingerprint sequence in step 67) in step 73. If any of the fingerprints that are extracted by the fingerprint detector are found to match any of the fingerprint sequences that are stored in the memory device 14 in step 75, an associated action that is also stored in the memory device 14 and attached to the fingerprint sequence is executed in step 79 on the specified data in accordance with FIG. 1. After step 67 has been performed, step 62 may be executed again. If a match is not found in step 75, step 70 may be executed again. The aforementioned processes (e.g., steps 65-67 and steps 70-79) may be performed simultaneously although generally steps 65-67 must be performed at least once prior to performing steps 70-79. The aforementioned processes may also be performed sequentially in accordance with FIG. 2.

While embodiments of the present invention have been described herein for purposes of illustration, many modifications and changes will become apparent to those skilled in the art. Accordingly, the appended claims are intended to encompass all such modifications and changes as fall within the true spirit and scope of this invention.

1. A system, comprising: a fingerprint extractor, a fingerprint detector, a control device, an input device, a memory device, and an output device, wherein the fingerprint extractor is adapted to accept a signal comprising a data stream and extract a first fingerprint of user specified data existing within the data stream, wherein the input device is adapted to accept a first command to extract the first fingerprint and accept a second command to attach an associated action to the first fingerprint, wherein the memory device is adapted to store the first fingerprint and the associated action, wherein the fingerprint detector is adapted to accept the signal comprising the data stream, continuously extract a plurality of fingerprints from the data stream, and compare the plurality of fingerprints to the first fingerprint stored in the memory device for a match between the first fingerprint and any fingerprint of the plurality of fingerprints, wherein the control device is adapted to execute the associated action upon detection of a match, and wherein the output device is adapted to output the data stream comprising the executed action.

2. The system of claim 1, wherein feedback data is outputted to the output device, wherein the feedback data comprises a sample of the user specified data that has been marked by the first fingerprint, and wherein the feedback data comprises a message regarding the associated action to be executed.

3. The system of claim 1, wherein the data stream comprises an audio data stream.

4. The system of claim 1, wherein the data stream comprises a video data stream.

5. The system of claim 1, wherein the signal comprises a television (TV) signal comprising an audio data stream and a video data stream.

6. The system of claim 5, wherein the first fingerprint is associated with a commercial comprising a commercial data stream.

7. The system of claim 6, wherein the first fingerprint comprises a first specified sample of the commercial data stream, wherein a second fingerprint is extracted from the commercial data stream, wherein the second fingerprint comprises a second specified sample of the commercial data stream, and wherein the associated action is executed on a data block of the commercial stream that is between the first fingerprint and the second fingerprint.

8. The system of claim 7, wherein the first specified sample and the second specified sample are video samples.

9. The system of claim 7, wherein the first specified sample and the second specified sample are audio samples.

10. The system of claim 7, wherein the associated action comprises muting audio data within the data block.

11. The system of claim 7, wherein the associated action comprises adjusting a decibel level audio data within the data block.

12. The system of claim 7, wherein the associated action comprises muting video data within the data block.

13. The system of claim 5, wherein the first fingerprint is associated with a TV show comprising a TV show data stream.

14. The system of claim 13, wherein the first fingerprint comprises a first specified sample of the TV show data stream, wherein a second fingerprint is extracted from the TV show data stream, wherein the second fingerprint comprises a second specified sample of the TV show data stream, and wherein the associated action is executed on a data block of the TV show data stream that is between the first fingerprint and the second fingerprint.

15. The system of claim 14, wherein the first specified sample and the second specified sample are video samples.

16. The system of claim 14, wherein the first specified sample and the second specified sample are audio samples.

17. The system of claim 14, wherein the associated action comprises muting audio data within the data block.

18. The system of claim 14, wherein the associated action comprises adjusting a decibel level audio data within the data block.

19. The system claim 14, wherein the associated action comprises muting video data within the data block.

20. The system of claim 5, wherein the TV signal is selected from the group consisting of a cable TV signal, a satellite TV signal, and a standard TV signal.

21. The system of claim 7, wherein the first fingerprint and the second fingerprint each comprise a string of 32 bit words.

22. The system of claim 1, wherein the system is a TV.

23. The system of claim 1, wherein the output device is a TV.

24. A method, comprising: providing a system comprising a fingerprint extractor, a fingerprint detector, a control device, an input device, memory device, and an output device; receiving by the fingerprint extractor a signal comprising a data stream; receiving by the input device a first command to generate a first fingerprint of specified data within the data steam; extracting by the fingerprint extractor the first fingerprint of the specified data within the data stream; receiving by the input device a second command to attach an associated action to the first fingerprint; storing by the memory device the first fingerprint and the associated action; receiving by the fingerprint detector the signal comprising the data stream and continuously extracting a plurality of fingerprints from the data; comparing by the fingerprint detector the plurality of fingerprints to the first fingerprint for a match between the first fingerprint and any fingerprint of the plurality of fingerprints; and executing by the control device the associated action upon a detection of a said match outputting by the output device the datastream comprising the executed associated action.

25. The method of claim 24, further comprising outputting by the output device feedback data, wherein the feedback data comprises a sample of the user specified data that has been marked by the first fingerprint, and wherein the feedback data comprises a message regarding the associated action to be executed.

26. The method of claim 24, wherein the data stream comprises an audio data stream.

27. The method of claim 24, wherein the data stream comprises a video data stream.

28. The method of claim 24, wherein the signal comprises a television (TV) signal comprising an audio data stream and video data stream.

29. The method of claim 28, wherein the first fingerprint is associated with a TV commercial comprising a TV commercial data stream.

30. The method of claim 29, wherein the first fingerprint comprises a first specified sample of the commercial data stream; extracting by the fingerprint extractor a second fingerprint comprising a second specified sample of the commercial data stream; and executing by the control device the associated action on a data block of the commercial data stream that is between the first fingerprint and the second fingerprint.

31. The method of claim 30, wherein the first specified sample and the second specified sample are video samples.

32. The method of claim 30, wherein the first specified sample and the second specified sample are audio samples.

33. The method of claim 30, wherein the associated action comprises muting audio data within the data block.

34. The method of claim 30, wherein the associated action comprises adjusting a decibel level of audio data within the data block.

35. The method of claim 30, wherein the associated action comprises muting video data within the data block.

36. The method of claim 28, wherein the first fingerprint is associated with a TV show comprising a TV show data stream.

37. The method of claim 36, wherein the first fingerprint comprises a first specified sample of the TV show data stream; extracting by the fingerprint extractor a second fingerprint comprising a second specified sample of the TV show data stream; and executing by the control device the associated action on a data block of the TV show data stream that is between the first fingerprint and the second fingerprint.

38. The method of claim 37, wherein the first specified sample and the second specified sample are video samples.

39. The method of claim 37, wherein the first specified sample and the second specified sample are audio samples.

40. The method of claim 37, wherein the associated action comprises muting audio data within the data block.

41. The method of claim 37, wherein the associated action comprises adjusting a decibel level audio data within the data block.

42. The method of claim 37, wherein the associated action comprises muting video data within the data block.

43. The method of claim 28, wherein the TV signal is selected from the group consisting of a cable TV signal, a satellite TV signal, and a standard TV signal.

44. The method of claim 30, wherein the first fingerprint and the second fingerprint each comprise a 32 bit word.

45. The method of claim 30, wherein the first fingerprint and the second fingerprint each comprise a string of 32 bit words.

46. The method of claim 24, wherein the system is a TV.

47. The method of claim 24, wherein the output device is a TV.
